(19) United States
(12) Patent Application Publication
(10) Pub. No.: US 2009/0059344 A1
(43) Pub. Date: Mar. 5, 2009

(54) MICROMIRROR DEVICE

(75) Inventors: Cornel MARXER, Neuchatel (CH); Peter Herbst, Bevaix (CH); Michael Zickar, Aarburg (CH); Wilfried Noell, Neuchatel (CH)

Correspondence Address: BIRCH STEWART KOLASCH & BIRCH, PO BOX 747, FALLS CHURCH, VA, 22040-0747, US

(73) Assignee: SERCALO Microtechnology Ltd., Schaan (LI)

(21) Appl. No.: 12/181,934

(22) Filed: Jul. 29, 2008

(30) Foreign Application Priority Data
Jul. 31, 2007 (EP) 07 405 226.7

(51) Int. Cl. G02B 26/00

(52) U.S. Cl. 359/290

(57) ABSTRACT

A micromirror device (21) comprises an electrostatically actuable micromirror (25) and also a frame (27) and a base (9). The micromirror (25) is cardanically suspended in the base (9) via the frame (27) in that it is connected to the frame (27) via two articulated joints and the frame (27) is connected to the base (9) via two further articulated joints. In this way, the micromirror (25) can be actuated by application of an electrical voltage to correspondingly positioned electrodes, that is to say that one or both of the rotation axes defined by the two pairs of articulated joints are pivoted. The micromirror is then suspended in such a way that the two articulated joints defining one of the two rotation axes each comprise a torsion spring and the other two articulated joints defining the other of the two rotation axes each comprise a bending spring.

### TECHNICAL FIELD

The invention relates to a micromirror device comprising a mirror arrangement patterned from a semiconductor layer, which comprises a base structure, a micromirror and a frame structure arranged between the base structure and the micromirror, the micromirror is connected to the frame structure via two articulated joints defining a first rotation axis of the micromirror, and the frame structure is connected to the base structure via two articulated joints defining a second rotation axis, wherein the two rotation axes form an angle of greater than 0 degrees. The invention furthermore relates to a corresponding method for producing such a micromirror device.

### PRIOR ART

In modern telecommunications apparatuses, MEMS (microelectromechanical systems) products are often used for the processing of optical signals. Such systems are produced by methods which are very similar to the methods for producing integrated circuits. For the controlled forwarding of optical signals use is made of micromirrors, for example, which are patterned for example from a thin semiconductor layer, for example a thin silicon layer. Such micromirrors are formed and connected to the semiconductor material surrounding them in such a way that they can be pivoted about one or two axes in a targeted manner. In this way, a light beam incident on the micromirror can be reflected in a targeted manner to a specific location, for example onto one of a plurality of lenses, which couples the reflected light beam for example into a specific one of a plurality of optical fibres.

There are various possibilities for actuating such micromirrors, that is to say rotating or pivoting them about one or a plurality of the rotation axes thereof. One possibility consists in utilizing thermoelectric or piezoelectric effects, as is disclosed for example in EP 1 057 068 A1. The mirror 11 disclosed therein is connected to two bending beams 14 and 14′ via two torsion beams 12, 12′, wherein the torsion beams and the bending beams define a common rotation axis of the mirror. A thermomechanical or piezoelectric bending transducer 15 is situated on the bending beams 14, 14′. Mechanical stresses are induced in the bending beam by application of an electrical voltage, said stresses resulting in bending of the bending beams. By periodically changing the applied voltage, the mirror is caused to effect oscillation about the rotation axis of the mirror defined by the torsion and bending beams. If the frequency of the exciting bending oscillation is chosen such that it corresponds to a resonant frequency of the torsional oscillation, a particularly large oscillation amplitude can be achieved. Situated on the torsion beams 12, 12′ there is in each case a piezoresistive or a piezoelectric thin-film transducer 16 for detecting the torsional oscillation. In order to transmit the electrical signals to and from the thin-film transducers 16 and the bending transducers 15, the bending beams are provided with a corresponding metallization.

In such piezoelectrically or thermoelectrically actuated mirrors there is the problem that the systems may have a hysteresis, which is disadvantageous for precise driving of the mirror. This has an adverse effect particularly when, unlike in EP 1 057 068 A1, the mirror is not caused to effect oscillation, rather the intention is to implement in each case only individual rotary movements of the mirror in a controlled fashion. Moreover, the mechanical stresses in the bending beams can result in flowing and plastic deformations of the metal coating, which also entail a deformation of the coated substrate. This results in an altered switching behaviour of the mirrors and precise actuation is no longer possible.

U.S. Pat. No. 6,935,759 B1 discloses a further micromirror. The latter is suspended cardanically, wherein all the articulations are constructed substantially identically. Each of the articulations comprises a plurality of torsion beams (60-66) which are aligned parallel to the desired rotation axis and are interconnected in each case by stiff struts.

What is disadvantageous about this construction is that the movements of the mirror about its two rotation axes are not decoupled. In other words, when the mirror is actuated about one of its rotation axes, the mirror is also rotated about its second rotation axis, which is substantially perpendicular to the first rotation axis. Moreover, these combined torsional suspensions require a relatively large amount of space, such that, in contrast to what is often desired, a plurality of such mirrors cannot be arranged with a high fill factor in a space-saving array.

WO 2005/006052 A1 (Philips) discloses a scanning device of a projector, in which a rotary plate (53) is fixed to a base (56) by means of two torsion elements (55). In the rotary plate there is a cutout in which a reflection area (31) is fixed by means of two bending elements (30a, 30b). The reflection area is actuated in such a way that it oscillates at its resonant frequency. What is disadvantageous in this case is that a targeted actuation of the reflection area upwards or downwards with the position being retained is not possible owing to the design of the device as a scanner. Moreover, the movements about the two rotation axes are not cleanly decoupled from one another and the arrangement requires a large amount of space owing to the outer torsion elements. Furthermore, compressive or tensile loads can adversely affect the functioning of the scanning element.

Furthermore, such micromirrors which are suspended cardanically by means of four torsion beams are also known. In other words, the mirror is fixed to a frame by two torsion beams and the frame is fixed to the surrounding semiconductor material by two further torsion beams. If external tensile or compressive forces then act for example in the direction of that rotation axis which is defined by the two torsion springs connecting the frame to the surrounding semiconductor material, the resonant frequencies of said springs and hence the switching behaviour of the mirror can change significantly in comparison with the unloaded case.

In order to achieve a precise switching behaviour in the case of such micromirrors, such mirror arrangements are typically provided with a feedback in order to keep the position of the mirror stable, i.e. drift-free. Such arrangements are then usually also not suitable for a dense array arrangement, on account of the space requirement needed for them.

In other words, the previously known micromirrors based on MEMS technology are unsuitable either for a dense array arrangement or for a targeted deflection in a specific direction and retention of the deflection, require a large amount of space, their movements about their rotation axes are not decoupled from one another or they need a feedback system in order to keep the position of the mirror stable (drift-free).

### SUMMARY OF THE INVENTION

It is an object of the invention, therefore, to provide a micromirror device associated with the technical field mentioned in the introduction, and also a corresponding production method, which avoid the abovementioned disadvantages and which have, in particular, a drift-free, precisely reproducible switching behaviour, wherein a plurality of such micro-mirror devices can also be arranged very densely in an array, that is to say with a high fill factor.

The object is achieved in the manner defined by the features of Claim 1. The micromirror device patterned from a semiconductor layer comprises a mirror arrangement having a base structure, a micromirror and a frame structure arranged between the base structure and the micromirror. The micromirror is connected to the frame structure via two articulated joints defining a first rotation axis of the micromirror and the frame structure is connected to the base structure via two articulated joints defining a second rotation axis. In this case, the two rotation axes form an angle of greater than 0 degrees, preferably an angle of substantially 90 degrees. According to the invention, now those articulated joints which define the first rotation axis comprise the torsion springs and those articulated joints which define the second rotation axis comprise the bending springs. In other words, the bending springs are as it were the outer connections that connect the frame structure to the surrounding base structure, and the torsion springs are the inner connections that connect the frame structure to the mirror.

The actuation of the micromirror is preferably effected electrostatically. In this case, an electric field is generated in the vicinity of the micromirror and acts on part of the mirror. Since the mirror typically has a doping, that is to say charged particles, that part of the mirror is correspondingly attracted or repelled by the electric field and the mirror is in this way pivoted about one or more of its rotation axes.

The embodiment according to the invention of the suspension of the micromirror at the frame structure and the frame structure at the base structure has the advantage that the movements, that is to say the rotations of the micromirror about its two rotation axes, are practically completely decoupled from one another. Furthermore, it is the case that the bending beams require only very little space in the direction of the rotation axis defined by them. As a result, space can be saved at least in this direction and a high fill factor can thus also be achieved. By virtue of the micromirror preferably being actuated electrostatically, it is possible, moreover, to avoid the hysteresis effects of a piezoelectric or thermoelectric actuation. Moreover, in this way, no mechanical loadings of the mirror arise in the event of mechanical stresses in the direction of the rotation axis defined by the bending springs, since such forces are not transmitted to the micromirror. In other words, the switching behaviour of the micromirror scarcely changes or does not change even in the event of a mechanical compressive or tensile loading, for example on account of a change in temperature or on account of other influences of the housing such as, for instance, as a result of the packaging.

The overall result, therefore, is a precise, reproducible and drift-free switching behaviour of the micromirror. This renders feedback totally superfluous. At the same time, as a result of the lower mechanical loading of the arrangement, the service life of said arrangement can also be increased.

The frame structure is also referred to hereinafter simply as frame, and the base structure simply as base.

The abovementioned semiconductor layer is preferably a silicon layer, for example the silicon layer of a silicon wafer, since the processes and methods required for processing such silicon layers are very well known from the fabrication of semiconductor chips. Therefore, such a micromirror device is also referred to hereinafter as a mirror chip.

This arrangement wherein the bending springs are the outer connections and the torsion springs are the inner connections has the advantage over the opposite arrangement that the entire micromirror device is virtually decoupled from the rest of the base via the bending springs. Compressive and tensile loadings in the direction of the rotation axis of the mirror that is defined by the bending springs are absorbed by the bending springs. Compressive and tensile loadings in the direction of the other rotation axis, that is to say in the direction of the rotation axis defined by the torsion springs, are not transmitted to the mirror at all since the sole connection between base and mirror runs via the bending springs. Moreover, since the torsion springs, which take up a relatively large amount of space in their longitudinal direction, are in an inner location, the total space requirement of the mirror arrangement can be minimized. This is because the torsion springs can then at least partly be patterned from the frame structure and also from the mirror area and, in this way, do not require any additional space in their longitudinal direction.

In principle, the bending springs can comprise a plurality of interconnected bending beams arranged perpendicular to their rotation axis. In order to minimize the space requirement, however, the bending springs preferably comprise precisely one bending beam arranged perpendicular to the second rotation axis, said bending beam being connected to the frame at a first end and to the base at a second end. As a result, mechanical stresses in the direction of the second rotation axis which originate for example from thermal stresses or stresses originating from the packaging can be compensated for by an offset of the bending beams.

In one preferred embodiment of the invention, the bending beams have a height in the range of 2 to 20 micrometres, a width in the range of 1 to 4 micrometres and a length in the range of 50 to 300 micrometres. Although other dimensionings of the bending beams are perfectly possible as well, these values have proved to be advantageous with regard to the desired properties (natural frequencies, stiffness, producibility, decoupling of the rotations about the two rotation axes of the mirror). Particularly preferably, the bending beams have a height of approximately 5 micrometres, a width of approximately 2 micrometres and a length of approximately 150 micrometres.

The torsion springs, too, can in principle comprise a plurality of torsion beams arranged parallel to the rotation axis defined by them. However, here, too, it is preferred for the purposes of simpler fabrication if each torsion spring comprises precisely one torsion beam arranged parallel to the first rotation axis. Said torsion beam is connected to the micromirror at a first end and to the frame at a second end.

In one preferred embodiment variant, the torsion beam is connected to the frame via a transverse beam arranged transversely with respect to said torsion beam, wherein the torsion beam is connected to the transverse beam approximately centrally and the transverse beam is connected by its two ends to the frame.

In this case, the torsion beams preferably have a height in the range of 2 to 20 micrometres, a width in the range of 0.5 to 3 micrometres and a length in the range of 50 to 300 micrometres. The torsion beams, too, can of course have dimensions deviating from the above, depending on the desired application. However, torsion beams having dimensions in the ranges mentioned above have likewise proved to be advantageous with regard to the desired properties (natural frequencies, stiffness, producibility, decoupling of the rotations about the two rotation axes of the mirror). Particularly preferably, the torsion beams have a height of approximately 5 micrometres, a width of approximately 1 micrometre and a length of approximately 130 micrometres. Therefore, the torsion beams are preferably approximately of the same height as the bending beams, but only approximately half as wide and typically somewhat shorter than said bending beams.

Depending on the semiconductor material used, the reflectivity is more or less high and may even be sufficient depending on the application. In order to increase the reflectivity, that surface of the micromirror which is used for forwarding a light beam can be provided with a metallization. That is to say that the micromirror has a metal coating on at least one surface of the semiconductor layer. If the mirror is coated with metal only on one side, this can result in a deformation of the mirror surface, that is to say that the mirror surface is curved. Particularly preferably, therefore, both surfaces of the semiconductor layer, that is to say both mirror surfaces, are provided with a metal coating. As a result, the radius of curvature of the mirror surface can be significantly increased, thus resulting in a mirror having as planar a surface as possible.

For the metallization, it is possible in principle to use any desired metal such as, for example, gold, silver, aluminium, copper or any other metal having a suitable reflectivity for the desired spectral range, wherein, on account of its properties in this regard and further properties, gold is best suited and therefore preferably used.

Typically, the entire mirror area is provided with a metal layer. In one preferred embodiment of the invention, however, the mechanically stressed locations of the micromirror, in particular the torsion and bending springs, which as a rule are likewise coated, remain free of the metal coating. This is achieved by virtue of the fact that the regions which are not to be coated are covered or remain covered prior to the application of the metal coating.

It the mechanically stressed regions, for example the springs, were likewise metallized, the springs could likewise deform in the event of a plastic deformation or in the event of a flowing of the metal. These deformations are at least in part irreversible and result in a deformation of the spring, whereby the spring has an offset in the angle of curvature even without mechanical loading. The switching behaviour of the mirror would correspondingly be adversely influenced—it drifts. By not metallizing the springs, these undesirable effects can be avoided.

The frame structure or the base structure can also be metallized. All that is important is that the springs or if need be further mechanically stressed regions are not metallized.

As already mentioned, such a micromirror device can be produced, i.e. patterned, from a semiconductor layer such as a silicon layer, for example, by means of methods such as are known from the production of integrated circuits. While any type of wafer is suitable for this, in principle, SOI (silicon on insulator) wafers are particularly suitable for this. Such SOI wafers comprise a so-called top layer (device layer) composed of silicon having a thickness in the range of a few micrometres to a few hundred micrometres, an insulation layer (buried oxide layer or BOX layer) comprised of silicon oxide having a thickness in the range of fractions of micrometres to a few micrometres, and also a substrate layer (handle layer) once again composed of silicon having a thickness in the range of a few dozen micrometres to a few hundred micrometres. In this case, the silicon layers are typically doped, for example with boron.

SOI wafers are particularly suitable for the production of such micromirror devices since they already have an insulation layer, which—as will be described further below—plays an important role for the production of the mirrors.

As already mentioned, the mirrors are actuated by electric fields. The latter can be generated per se in any desired manner. It is merely necessary to ensure that the fields are formed with their magnitude such that they act in each case principally on a specific part of a mirror, such that the latter pivots about one or more of its rotation axes under the effect of such an electric field. In order to achieve individual pivoting movements or else an oscillation of the mirror in a targeted manner, said fields have to be able to be switched on and off again in a targeted manner.

In one preferred embodiment of the invention, the electric or electrostatic fields required for the actuation of a mirror are generated by means of an electrode arrangement patterned from the top layer of a second SOI wafer, wherein such an electrode arrangement comprises a plurality of electrodes. It comprises three electrodes, for example, one for tilting the mirror about one of the two rotation axes and two more for tilting the mirror respectively in both directions about the other rotation axis. Such a device comprising one (or more) electrode arrangement patterned from a silicon layer is therefore also referred to hereinafter as an electrode chip.

For this purpose, the mirror arrangement and the electrode arrangement are placed against one another in such a way that that surface of the top layer which is remote from the insulation layer of the first SOI wafer and that surface of the top layer which is remote from the insulation layer the second SOI wafer face one another. They are positioned in such a way that the electrodes and the micromirror are opposite one another and have a defined spacing with respect to one another. As a result, a precise electrostatic actuation of the micromirror is possible by an electrical voltage being applied to at least one of the electrodes.

In the case of such electrostatic actuation of the micromirror it can happen that external electrostatic fields are also present. Thus, by way of example, adjacent electrodes or conductor tracks can result in interference fields (crosstalk) which influence the switching behaviour of the mirror in an undesired and adverse manner. This is because owing to such external fields, the mirror in a rest position can already have an offset angle, i.e. be deflected from its original rest position. As a result, the mirror can no longer be pivoted precisely and in a targeted manner by a specific angle about one of its axes (the mirror “drifts”).

If external interference fields of this type are not present, for example if an individual micromirror is involved, or if the fields in the region of the mirror are sufficiently small, these fields can be disregarded. It is not necessary to implement any special measures in this case.

Such interference fields are often present, however, for example if a plurality of such micromirrors are arranged alongside one another. In such cases, by way of example, the electrodes and conductor tracks of an adjacent mirror can cause such interference fields. However, their “own” conductor tracks can also result in such interference fields. In order to avoid negative effects of such interference fields, in a further preferred embodiment of the invention, the electrode arrangement is at least partly surrounded by a screen patterned from the top layer of the second SOI wafer, said screen being connected to earth. Preferably, the electrode arrangement is essentially completely surrounded by the screen. By means of this screen, the electrodes are screened from external electric fields. The mirror no longer “drifts” and can consequently be driven precisely and in a targeted manner.

In the case of such a micromirror device comprising a mirror arrangement and an associated electrode arrangement for actuating the mirror, it is extremely important for the electrodes and the mirror to be positioned precisely with respect to one another. If the electrodes are shifted, for example, the mirror can no longer be actuated correctly, under certain circumstances, since the electrostatic field generated by the electrodes no longer acts as desired on a specific partial region of the mirror, but rather on a plurality of parts, a different part or no longer any part at all of the mirror.

Furthermore, it is also important for the electrodes and the mirror to have a defined spacing with respect to one another. As a result of variations in the individual process steps it can happen that, in particular from wafer to wafer, but also within a wafer, the spacings of the mirrors with respect to the associated electrodes are not equal in magnitude at all points. If the spacing is less than or greater than the defined spacing, the electrostatic force acting on the mirror changes here and therefore so does the switching behaviour of the relevant mirror. It can thus be the case that the angle of rotation of the mirror becomes too large or too small and the light beam to be reflected misses the desired target.

For mutually aligning the chip with the mirror arrangement and the chip with the associated electrode arrangement it is possible to use the methods known for this. These include so-called flip-chip bonding, for example, by means of which the two chips can firstly be connected to one another and secondly also be mutually aligned. For mutually aligning the two chips, however, it is also possible to provide a cutout, for example a hole or a groove, on one of the chips and a corresponding projection, such as a pin or a spring, for instance, on the other chip. Cutout and projection are then formed in such a way that they intermesh and the two chips are correspondingly positioned. However, in this case it is often difficult for the two chips to comply with a defined spacing with respect to one another after they have been joined together.

In one preferred embodiment of the invention, the micromirror device therefore comprises a combined spacing and aligning device. The latter comprises a first cutout on that surface of the top layer with the mirror arrangement which is remote from the insulation layer of the first SOI wafer and a second cutout on that surface of the top layer with the electrode arrangement which is remote from the insulation layer of the second SOI wafer. The two cutouts are dimensioned and positioned in such a way that, when the two top layers with the corresponding surfaces are placed against one another, said cutouts are opposite one another and form a free space between or in the two top layers of the two SOI wafers. The spacing and aligning device furthermore comprises a spacer. The latter is inserted, then, between the two top layers in such a way that it is situated in said free space.

A fibre, for example a glass fibre, having a precisely defined, circular-disc-shaped cross section is preferably used as the spacer and the cutouts are preferably formed as grooves having a specific width and depth. The width of the grooves corresponds approximately to the diameter and the depth of the grooves approximately to the radius of the fibre. In this way, not only is it possible for the two chips to be mutually aligned precisely, it is also possible for the spacing between the two chips to be set extremely accurately by way of the diameter of the fibre. This is because said spacing depends exclusively on the diameter of the fibre, that is to say that process variations during the production of the chips have no influence on the spacing between the electrodes and the mirror.

The spacer is inserted into one of the two cutouts before the two chips are joined together. To prevent said spacer from falling out again during the joining-together process, at least one of the two cutouts comprises a corresponding holding device for the spacer. Said holding device comprises, for example, at least one leaf spring which is shaped in said cutout and holds the spacer in the cutout.

Although it would be possible for the cutouts not to be equipped with a holding device of this type, in this case the process of joining together the two chips is more difficult and associated with more outlay.

Although there are also applications where in each case only an individual micromirror as described above is required, nevertheless a multiplicity of micromirror devices as described above are often required. These micromirror devices are then preferably arranged in an array.

In the case of such an array of micromirror devices, the individual micromirror devices are typically not patterned from respectively different SOI wafers, rather all the mirror arrangements are patterned from the top layer of a single, first SOI wafer. If the micromirror devices additionally also comprise an electrode arrangement as described above, the individual electrode arrangements are typically likewise not patterned from respectively different SOI wafers, rather all the electrode arrangements are patterned from the top layer of a single, second SOI wafer.

In this case, too, the mirror arrangements and the electrode arrangements, as described above, are placed against one another in such a way that that surface of the top layer which is remote from the insulation layer of the first SOI wafer and that surface of the top layer which is remote from the insulation layer of the second SOI wafer face one another and that an electrode arrangement and a mirror arrangement are in each case opposite one another and have a defined spacing with respect to one another.

Such an array of micromirror devices can comprise, in principle, any desired number of rows and columns of micromirror devices. Preferably, however, the array comprises two to four rows of micromirror devices with parallel first and coincident second rotation axes and at least two columns of micromirror devices with coincident first and parallel second rotation axes. The number of columns is typically in the range of a few columns up to a few dozen columns.

In the case of a higher number of rows and columns, the effects of mechanical stresses on the large-area, thin membrane (base) are considerable. On account of compressive stresses, the base has bulges which can abruptly assume other stable bulge states as a result of minimal forces. In other words, this membrane is bistable or usually even multistable. As a result, original directions of different micromirror surfaces in the array are altered in an undefined manner. However, the curvature of the micromirror surface itself in this case remains as small as possible, that is to say that the radius of curvature remains as large as possible and the mirror surface thus remains as even as possible, since the mirror is decoupled from the base via the torsion and bending springs and, consequently, only the base-frame structure is affected by this bulge. In order to compensate for such mechanical stresses in the direction of the first rotation axes, the top layer of the first SOI wafer, that is to say the top layer with the mirror arrangements, advantageously has a cutout between the second and the third row of micromirror devices. In other words, the top layer is preferably completely severed between the second and the third row of micromirror devices, such that the first two rows and the last two rows virtually each lie on a separate portion of the top layer.

In order to obtain an even larger mirror array, it is also possible, of course, for a plurality of such arrays to be placed alongside one another and connected together.

As likewise already described, the individual bending springs of each mirror serve to compensate for mechanical stresses in the direction of the second rotation axes.

In order that such forces can be compensated for even better, the top layer of the first SOI wafer is advantageously subdivided further. It is subdivided into separate tongues for example between the micromirror devices of a row, such that in each case the two mirrors lying one above another in the first and the second and, respectively, the third and the fourth row lie in a separate region of the top layer. In other words, the portion of the top layer with the first two rows and also the portion of the top layer with the last two rows is divided by said cutouts into a plurality of tongues which in each case comprise two adjacent mirrors respectively of a row.

In the method for producing a micromirror device such as has been described above, a mirror arrangement comprising a base structure, a micromirror and a frame structure arranged between the base structure and the micromirror is patterned from a semiconductor layer, in particular a silicon layer. Furthermore, two articulated joints that define a first rotation axis of the micromirror and connect the micromirror to the frame structure are patterned from the semiconductor layer and two articulated joints that define a second rotation axis and connect the frame structure to the base structure are patterned from the semiconductor layer, wherein the two rotation axes form an angle of greater than 0 degrees.

According to the invention, now two of the articulated joints defining one of the two rotation axes are patterned from the semiconductor layer as an articulated joint comprising a respective torsion spring and the other two articulated joints defining the other of the two rotation axes are patterned from the semiconductor layer as an articulated joint comprising a respective bending spring.

Preferably, the articulated joints defining the first rotation axis are patterned from the semiconductor layer as an articulated joint comprising a respective torsion spring and the articulated joints defining the second rotation axis are patterned from the semiconductor layer as an articulated joint comprising a respective bending spring.

In this case, at least one surface of the semiconductor layer of the micromirror is advantageously provided with a metal coating. Preferably, however, the torsion springs and the bending springs are kept free of the metal coating.

As already described above, the mirror arrangement is patterned from the semiconductor layer of an SOI wafer that is referred to as the top layer. The electrode arrangement having in each case a plurality of electrodes is likewise patterned from the top layer of a second SOI wafer. In this case, the mirror arrangement and the electrode arrangement are placed against one another in such a way that the electrodes and the micromirror are opposite one another and have a defined spacing with respect to one another.

This can be done for example by the mirror arrangement and the electrode arrangement being placed against one another in such a way that that surface of the top layer which is remote from the insulation layer of the first SOI wafer and that surface of the top layer which is remote from the insulation layer of the second SOI wafer face one another. However, it can also be done by the mirror arrangement and the electrode arrangement being placed against one another in such a way that that surface of the substrate layer which is remote from the insulation layer of the mirror wafer and that surface of the top layer which is remote from the insulation layer of the electrode wafer face one another.

In order to correctly join together the mirror arrangement and the electrode arrangement in the example in which the two top layers face one another, advantageously a first cutout is patterned on that surface of the top layer which is remote from the insulation layer of the first SOI wafer and a second cutout is patterned on that surface of the top layer which is remote from the insulation layer of the second SOI wafer. During the joining-together process, a spacer is inserted into a free space formed by the two cutouts between or in the two top layers of the two SOI wafers.

In the other example, where the substrate layer of the mirror wafer faces the top layer of the electrode wafer, the spacing between mirror and electrodes is essentially set by way of the layer thickness of the substrate layer and the alignment is effected by means of defined reference areas on one of the two chips and corresponding reference or bearing points on the respective other chip. During the joining-together process, the reference areas are brought into contact with the corresponding reference points, such that not only the spacing of the two chips but also the horizontal alignment thereof is defined precisely. By means of springs that are patterned from the wafer layers for example opposite a reference area, the two chips are pressed onto one another and thus mutually aligned and held in position.

In a method for producing a micromirror arrangement such as has been described above, advantageously a plurality of mirror arrangements are patterned from the top layer of the first SOI wafer and a number of electrode arrangements corresponding to the plurality of mirror arrangements are patterned from the top layer of a second SOI wafer. The mirror arrangements and the electrode arrangements are subsequently placed against one another in such a way that an electrode arrangement and a mirror arrangement are in each case opposite one another and have a defined spacing with respect to one another.

Further advantageous embodiments and combinations of features of the invention will become apparent from the following detailed description and the totality of the patent claims.

### BRIEF DESCRIPTION OF THE DRAWINGS

The drawings used for elucidating the exemplary embodiment show:

FIG. 1 shows a schematically illustrated micromirror according to the invention;

FIG. 2 shows a schematically illustrated further micromirror according to the invention;

FIG. 3 shows a bending spring of the mirror from FIG. 2 in an enlarged illustration in an unloaded state;

FIG. 4 shows the bending spring from FIG. 3 under loading;

FIG. 5 shows a schematically illustrated electrode arrangement for the micromirror from FIG. 2;

FIG. 6 shows a schematically illustrated cross section through a micromirror device according to the invention comprising a micromirror and an associated electrode arrangement;

FIG. 7 shows a schematically illustrated plan view of the positioning and spacing device from FIG. 6;

FIG. 8 shows an array of micromirrors in accordance with FIG. 2;

FIG. 9 shows an array of electrode arrangements in accordance with FIG. 5;

FIG. 10 shows a schematically illustrated excerpt from a cross section through the arrays from FIGS. 8 and 9 firstly without and secondly with an activated electrode;

FIG. 11 shows a schematic illustration of the process steps for producing a micromirror arrangement according to the invention;

FIG. 12 shows a schematic illustration of the process steps for producing an electrode arrangement;

FIG. 13 shows a schematic illustration of the process steps when joining together a mirror chip and an electrode chip;

FIG. 14 shows a schematic illustration of a further exemplary embodiment of a torsion spring for a micromirror according to the invention;

FIG. 15 shows a schematically illustrated cross section through a further embodiment of a micromirror device according to the invention comprising a micromirror and an associated electrode arrangement;

FIG. 16 shows a schematically illustrated plan view of the mirror chip of the micromirror device from FIG. 15; and

FIG. 17 shows a schematically illustrated plan view of the electrode chip of the micromirror device from FIG. 15.

In principle, identical parts are provided with identical reference symbols in the figures.

### WAYS OF EMBODYING THE INVENTION

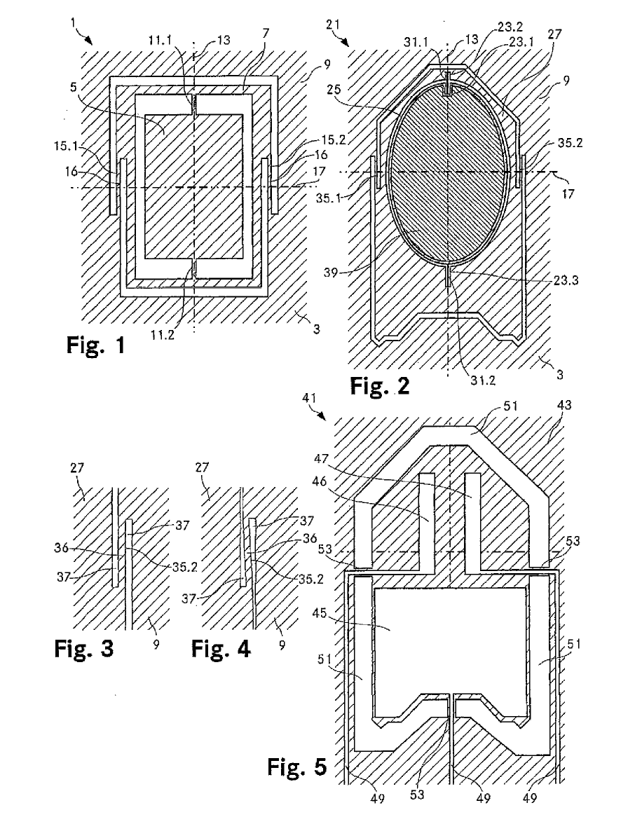

FIG. 1 shows a schematic illustration of a micromirror arrangement 1 according to the invention, said arrangement being patterned from a substrate, in this case from a thin silicon layer 3 such as e.g. the top layer of an SOI wafer. The micromirror arrangement 1 comprises a mirror 5, a frame 7 and a base 9. The mirror 5 is connected to the frame 7 via two torsion springs 11.1, 11.2, which define a first rotation axis 13. The frame 7 in turn is connected to the base 9 via two bending springs 15.1, 15.2, which define a second rotation axis 17.

The frame 7 forms together with the torsion springs 11.1, 11.2 and the bending springs 15.1, 15.2 virtually a cardanic suspension of the mirror 5 in the base 9. The frame 7 is formed so as to correspondingly run around the mirror 5 in a ring-shaped manner, such that it completely surrounds the mirror 5.

The mirror 5 is formed in rectangular fashion in this example. The torsion springs 11.1, 11.2 are fitted to two opposite sides of the mirror 5 and the bending springs 15.1, 15.2 are fitted to the other two opposite sides of the mirror 5. Accordingly, here the frame 7, too, is formed in substantially rectangular fashion. However, the form of the mirror 5 and of the frame 7 is unimportant, in principle, and prescribed if need be by the planned application. Mirror and frame can assume any conceivable form, in principle, as long as it is possible to rotate the mirror in the frame and the frame in the base about the axes defined by the springs. Besides the rectangular form shown, a substantially round or oval or elliptical form of the mirror and correspondingly also of the frame is appropriate, for example.

The torsion springs 11.1, 11.2 are formed as thin torsion beams which are arranged parallel to the rotation axis 13 and are connected to the mirror 5 at one end and to the frame 7 at the respective other end. The bending springs 15.1, 15.2 likewise each comprise a thin bending beam 16 which is arranged at right angles to the rotation axis 17 and is connected to the frame at one end and to the base 9 at the respective other end. In this case, the bending beams 16 each merge directly into the frame 7 and respectively the base 9, such that the connections between the bending beams 16 and the frame 7 and respectively the base 9 do not contain any portions which are arranged parallel to the rotation axis 17. This is because such connection pieces could lead to a torsional rotation of the mirror 5 about a rotation axis defined by said connection pieces, which is intended to be prevented, however, in order that the rotational movements of the mirror are effected exclusively about the rotation axis 17. It should be taken into consideration that the entire area illustrated in a hatched manner in FIG. 1 is patterned integrally from the top layer, for example a thin silicon layer 3, by the removal of the white regions from the silicon layer 3.

FIG. 2 shows a further example of a mirror arrangement 21 according to the invention. In this example, the mirror 25 is formed in oval fashion and is again completely surrounded by a frame 27. Here, too, the mirror 25 is connected to the frame 27 via two torsion springs 31.1, 31.2 and the frame 27 is connected to the base 9 via two bending springs 35.1, 35.2. In contrast to FIG. 1, the upper (according to the illustration in FIG. 2) torsion spring 31.1 is not fixed to the outer edge of the mirror 25, but rather to the lower edge of a rectangular cutout 23.1 at the upper edge of the mirror 25. Likewise, the other end of the torsion spring 31.1 is not fixed to the inner edge of the frame 27, but rather to the upper edge of a rectangular cutout 23.2 at the upper edge of the frame 27. The lower torsion spring 31.2 in turn is indeed fixed to the outer edge of the mirror 25, but is likewise fixed to the lower edge of a rectangular cutout 23.3 at the lower edge of the frame 27.

The interspace between mirror 25 and frame 27 can be considerably reduced in size by virtue of these cutouts 23.1, 23.2, 23.3. Therefore, it is either possible to reduce the space requirement for the entire mirror arrangement 21 or it is possible e.g. also to increase the mirror area with the space requirement for the entire mirror arrangement 21 remaining the same. Such cutouts can, of course, also be omitted or alternatively provided for further fixing points of the torsion springs 31.1, 31.2.

The bending springs 35.1, 35.2 are in turn directly connected to the frame 27 and the base 3, respectively, such that a torsional movement of the mirror 25 about an axis that differs from the rotation axis 17 can be precluded.

FIG. 2 furthermore illustrates that the mirror 25 is provided with a metallization 39. In this example, said metallization 39 comprises a thin gold layer and covers practically the entire area of the mirror 25. However, the metallization 39 has not been applied to the silicon layer 3 in the region of the cutout 23.1, such that the torsion springs 31.1, 31.2 and also the bending springs 35.1, 35.2 are not covered by the metallization 39. If the torsion springs 31.1, 31.2 or the bending springs 35.1, 35.2 were likewise metallized, this could lead to a corrupted switching behaviour of the mirror. This is because the metallization would deform plastically during the pivoting of the mirror about the rotation axes 13, 17, this deformation no longer being completely reversible, such that the mirror in its rest position is no longer aligned completely parallel to the silicon layer 3. These effects can be reduced or completely prevented by omitting the metallization on the springs. In order to avoid deformations of the mirror surface, in addition the mirror 25 is also metallized on its rear side (not visible here), wherein the torsion springs 31.1, 31.2 and the bending springs 35.1, 35.2 are not metallized on their rear side either.

FIGS. 3 and 4 show an enlarged illustration of the bending spring 35.2 of the mirror 25. FIG. 3 shows the bending spring 35.2 in the unloaded state, that is to say when no forces act on the mirror arrangement 21 in the direction of the rotation axis 17. The interspaces 37 between the frame 27 and the bending beam 36 and between the bending beam 36 and the base 9 are in this case substantially equal in width at all points.

However, if forces do act on the mirror arrangement 21 in the direction of the rotation axis 17, these forces are taken up by the bending springs 35.1, 35.2, as is illustrated in FIG. 4. That is to say that such forces have no or only a negligible influence on the switching behaviour of the mirror 25 since the interspaces 37 are pressed together at their respective open ends by the forces acting and, as a result, are no longer equal in width at all points, but rather are triangular or trapezium-shaped. The upper end of the bending beam 36 is offset slightly towards the left by the force acting, and its lower end slightly towards the right, with the result that the bending beam 36 overall is slightly inclined.

FIG. 5 illustrates an electrode arrangement 41 such as can be used for example together with the mirror arrangement 21 from FIG. 2 in order to actuate the mirror 25, that is to say to rotate or pivot it about one or both rotation axes 13, 17.

Here, too, the hatched area represents a thin silicon layer 43. Here, however, the white areas do not correspond to substrate regions that have been removed, but rather to structures which have been patterned from the silicon layer 43 by the at least partial removal of the silicon layer 43 around these structures.

These structures comprise a plurality of electrodes 45, 46, 47 and associated conductor tracks 49 each proceeding from an electrode 45, 46, 47 and leading to a contact point (not illustrated). In addition, the electrodes 45, 46, 47 are surrounded by a screen 51 having passages 53 for the conductor tracks 49. Said screen 51 serves firstly for screening external electrical or electrostatic fields such as are generated for example by the conductor tracks 49 or else by adjacent electrode arrangements.

In the example illustrated, the mirror arrangement 21 and the electrode arrangement 41 are arranged one above another in such a way that the surfaces illustrated in FIGS. 2 and 5, respectively, face one another. In other words, the mirror arrangement 21 as illustrated in FIG. 2 is turned over through 180 degrees e.g. about an axis parallel to the rotation axis 13, with the result that the area visible in FIG. 2 points downwards. The mirror arrangement 21 is then placed onto the electrode arrangement 41 and fixed there. In this way, the electrode 45 is situated in the region of the lower half of the mirror 25 (according to the illustration in FIG. 2), and the electrodes 46 and 47 are situated in the right-hand region and in the left-hand region of the upper half of the mirror. If an electrical voltage is then applied to one of the three electrodes 45, 46, 47 via the conductor tracks 49, this electrode 45, 46, 47 generates an electrostatic field that acts on the corresponding region of the mirror 25 in such a way that this region is attracted by the electrode having voltage applied to it and the mirror 25 is consequently pivoted about one of its rotation axes 13 or 17. In this case, the angle of rotation depends, inter alia, on the magnitude of the applied voltage and also the physical dimensions of the mirror and the torsion and bending springs. It is also possible to apply a voltage simultaneously to a plurality of electrodes 45, 46, 47, for instance to the electrode 45 and one of the other two electrodes 46, 47, in order to pivot the mirror 25 about both axes.

FIG. 6 shows a schematically illustrated cross section through a micromirror device 60 according to the invention comprising a mirror chip 61 (also referred to hereinafter as MEMS chip) and an electrode chip 63.

The mirror chip 61 illustrated here is produced from an SOI wafer 65. The latter comprises a top layer 67 (device layer) composed of doped silicon, an insulation layer 69 (buried oxide layer or BOX layer) composed of silicon oxide and a substrate layer 71 (handle layer), likewise composed of doped silicon. It can readily be discerned that the mirror 75 with the frame 77, the bending springs 79.1, 79.2 and the base 81 are patterned from the top layer 67. The whole is held together by the supporting structures 72 of the substrate layer 71. In this example, the thickness of the mirror 75, of the frame 77, of the bending springs 79.1, 79.2 and of the base 81 is approximately 10 to 15 micrometres, the thickness of the insulation layer is approximately 1 to 5 micrometres and the thickness of the substrate layer left is approximately 400 micrometres. The silicon is doped with boron, for example.

The mirror 75 is provided with a gold layer 76 on its front side and its rear side. Other regions of the rear side of the mirror chip 61 are also metallized.

The electrode chip 63 is likewise produced from an SOI wafer 85, which in turn comprises a top layer 87 (device layer) composed of doped silicon, an insulation layer 89 (buried oxide layer or BOX layer) composed of silicon oxide and a substrate layer 91 (handle layer), likewise composed of doped silicon. The silicon is for example once again doped with boron. The electrodes 96, 97, the screen 101 and also the conductor tracks 99 and the bonding pads 100 have once again been patterned from the top layer 87. Earth areas 98 are additionally provided between the screens 101 and the electrodes 96, 97 and also between the electrodes 96 and 97, said earth areas being connected to earth during operation.

In the case of such structures, parasitic charges can accumulate on the insulation layer 89 in the interspaces 95 between the electrodes 96, 97, the screen 101 and the earth areas 98, in particular during the operation of the device. This can have the effect that said parasitic charges cause interference fields which, for their part, can in turn influence the mirror 75 and thereby alter the switching behaviour thereof. This problem can be solved for example by the height of the electrodes 96, 97, of the screen 101 and of the earth areas 98 simply being chosen to be sufficiently large in comparison with the width of the respective interspaces 95, such that the interference fields caused by the parasitic charges do not pass as far as their top side at all, but rather are as it were impounded in the interspaces 95. By way of example, the height of the electrodes 96, 97 and of the earth areas 98 is approximately 30 to 40 micrometres and the height of the screen 101 is approximately 150 micrometres, while the width of the interspaces 95 is in the range of 5 to 20 micrometres. The thickness of the insulation layer is approximately 1 to 3 micrometres and the thickness of the substrate layer is around 400-500 micrometres. In order to obtain this impounding effect, said interspaces 95 must have a height at least equal to their width.

A further possibility for avoiding interference fields consists in removing the insulation layer in the interspaces 95. In this case, however, the electrodes and the conductor tracks are also undercut, that is to say that the insulation layer below the electrodes and the conductor tracks is at least partly etched away. In this way, parasitic charges can flow away via the conductive silicon substrate connected to earth and therefore do not accumulate at all. While the undercutting does not constitute a problem in the case of the comparatively wide electrodes, it can happen in the case of the conductor tracks, however, that the insulation layer underneath is completely removed, for which reason the conductor tracks then virtually hang in the air. This increases the risk of short circuits. Therefore, the insulation layer should only be incipiently etched to an extent such that the narrow conductor tracks also still remain connected to the substrate by the insulation layer. The conductor tracks can also be metallized (e.g. by means of vapour deposition) without causing short circuits. Since the conductor tracks are only slightly undercut, the metal layer on the insulation layer (or the substrate) and the conductor track is interrupted by the shadow of the overhanging conductor track.

The arrangement in FIG. 6 additionally shows very well that the two SOI wafers are joined together by their front sides, i.e. top areas 67, 87. In other words, the rear side 68.2 of the top layer 67 rather than the front side 68.1 of said top layer serves as a mirror area. If the mirror arrangement is produced using an SOI wafer 65 in which the top layer has been bonded onto the insulation layer, the rear side 68.2 of the top layer 67 is additionally of optically better quality than the front side 68.1 of the top layer 67, which is advantageous for the use as a mirror surface.

FIG. 6 furthermore illustrates an aligning and spacing device. The latter comprises a cutout, referred to hereinafter as groove 111, in the top layer 67 of the mirror chip 61, a U-shaped groove 113 on the front side 88.1 of the electrode chip 63, and also a fibre 115, which has a circular-disc-shaped cross section and is inserted between the two grooves 111, 113. Situated in the groove 113 is a small pedestal 117, on which the fibre 115 bears. The height of the pedestal 117 is equal to the height of the electrodes 96, 97 and of the earth areas 98 since they are fabricated by the same process steps. In other words, the height of the pedestals 117, of the electrodes 96, 97 and of the earth areas 98 is always equally high—independently of the processes used. This means that the spacing between the electrodes 96, 97 and the mirror 75 depends practically exclusively on the diameter of the fibres 115, which is defined extremely accurately since such fibres can be procured commercially with different, standardized and correspondingly precise diameters. These fibres are optical waveguides, for example, which are composed of an optically transparent material. In other words, by a suitable choice of the fibres 115, the spacing between the electrodes 96, 97 and the mirror 75 can be set extremely precisely and above all exactly identically for each mirror/electrode combination, independently of the process used.

With this aligning and spacing device, therefore, it is possible not just for the mirror chip 61 and the electrode chip 63 to be mutually aligned precisely; it is also possible for the precise spacing between the mirror 75 and the associated electrodes 96, 97 to be set very accurately, with the result that the switching behaviour of the mirror becomes very accurate and reproducible. Preferably, at least two of such aligning and spacing devices are provided, wherein the two grooves 111 and 113 in this case form an angle with respect to one another that is greater than 0 degrees, preferably approximately 90 degrees. Instead of the cylindrical fibres 115, other objects such as balls, for example, could also be used as spacers. However, these are less practical than fibres in terms of handling during the mounting of the two wafers.

The connection of the two chips itself is effected by known methods such as, for example, so-called flip-chip bonding, by means of UV-curable adhesive or by soldering.

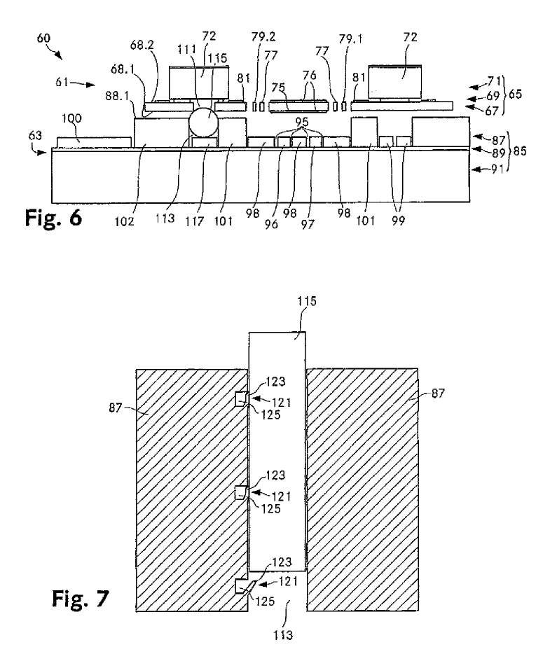

FIG. 7 shows a schematically illustrated, enlarged plan view of the positioning and spacing device from FIG. 6. To prevent the fibre 115 from falling down when the mirror chip 61 and the electrode chip 63 are joined together, one of the grooves, here for example the groove 113 in the top layer 87, comprises a holding device for the fibre 115. This holding device is illustrated in a plan view in FIG. 7. It comprises a plurality of leaf springs 121 patterned from the top layer 87 and having in each case a cutout 125 and a lug 123 that projects into the groove in the relaxed state. If the fibre 115 is inserted into the groove 113, the lug 123 of each leaf spring 121 is pressed into the corresponding cutout 125 and the spring force of the lugs 123 holds the fibre 115 firmly in the groove 113.

If the leaf springs 121 are situated in the top layer 87 of the electrode wafer, as illustrated, when the mirror chip 61 and electrode chip 63 are joined together, firstly the fibre 115 is inserted into the groove 113 and then the two top layers are placed one on top of another in such a way that the fibre 115 becomes located in the other groove 111.

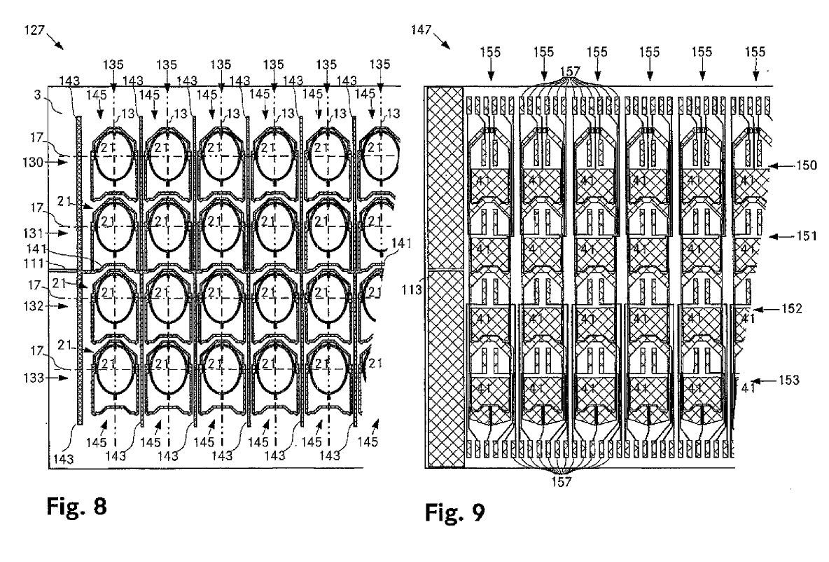

FIG. 8 shows a mirror chip 127 having a plurality of micromirror arrangements 21 in accordance with FIG. 2 which are patterned from a common wafer, that is to say from a common silicon layer 3. The micromirror arrangements 21 are arranged in an array which, in this example, comprises four rows 130, 131, 132, 133 and a multiplicity of columns 135, only the first few columns 135 being visible. The array comprises for example 32 columns 135.

The micromirror arrangements 21 of a row 130, 131, 132, 133 are arranged in such a way that in each case their first rotation axes 13 are parallel to one another and their second rotation axes 17 coincide. The micromirror arrangements 21 of each column 135 are correspondingly arranged in such a way that in each case their second rotation axes 17 are parallel to one another and their first rotation axes 13 coincide.

FIG. 8 illustrates in hatched fashion those areas of the silicon layer 3 which have been removed from the silicon layer 3, that is to say the top layer of the corresponding wafer. In order to reduce or eliminate the influence of bulges caused by mechanical stress and their change as a result of the action of force on individual micromirror devices, various cutouts are provided in the silicon layer 3. One of these cutouts 141 runs between the second row 131 and the third row 132 and virtually divides the silicon layer 3 into an upper part and a lower part.

Further cutouts 143 run in each case perpendicular to the cutout 141 on both sides of each column 135. As a result, two micromirror arrangements 21 in each case lie on a tongue 145 that is connected to the silicon layer 3 in each case only at the top and at the bottom. In this way it is possible to prevent changes in bulges of the base (membrane) as a result of force actions (temperature, mirror actuation).

FIG. 9 shows an electrode chip 147 associated with the mirror chip 127 from FIG. 8 and having a plurality of electrode arrangements 41 in accordance with FIG. 5 which are likewise arranged in an array. They are also patterned from a common wafer, that is to say from a common silicon layer 43. The array once again comprises four rows 150, 151, 152, 153 and a multiplicity of columns 155, only the first few columns 155 being visible. In this example, the array likewise comprises 32 columns 155, such that in each case precisely one electrode arrangement is opposite each mirror arrangement 21 if the mirror chip 127 and the electrode chip 147 are joined together with electrodes and mirrors facing one another.

Each of the conductor tracks of each electrode arrangement 41 is led onto a contact point 157, a so-called “bonding pad”. In this case, all contact points 157 for the conductor tracks of the upper two rows 150, 151 of electrode arrangements 41 are led onto a row of contact points 157 that is positioned above the electrode arrangements, and all the contact points 157 for the conductor tracks of the lower two rows 152, 153 of electrode arrangements 41 are led onto a row of contact points 157 that is positioned above the electrode arrangements. This arrangement of the contact points 157 in regular rows facilitates the production of the electrical contacts to a controller or voltage source (not illustrated).

As can be discerned in FIG. 5, the conductor tracks which respectively lead to the electrodes of an electrode arrangement 41 are in each case led through corresponding passages in the screens of each electrode arrangement 41. However, said passages are not at the same location in all the electrode arrangements 41. They are situated in each case at the locations most suitable for them.

The grooves 111 and 113 as have already been explained in more detail in connection with FIGS. 6-7 can furthermore be discerned in FIGS. 8 and 9. Said grooves serve here for mutually aligning the mirror chip and the electrode chip and also—with the aid of a fibre—for setting the mutual spacing between the two chips.

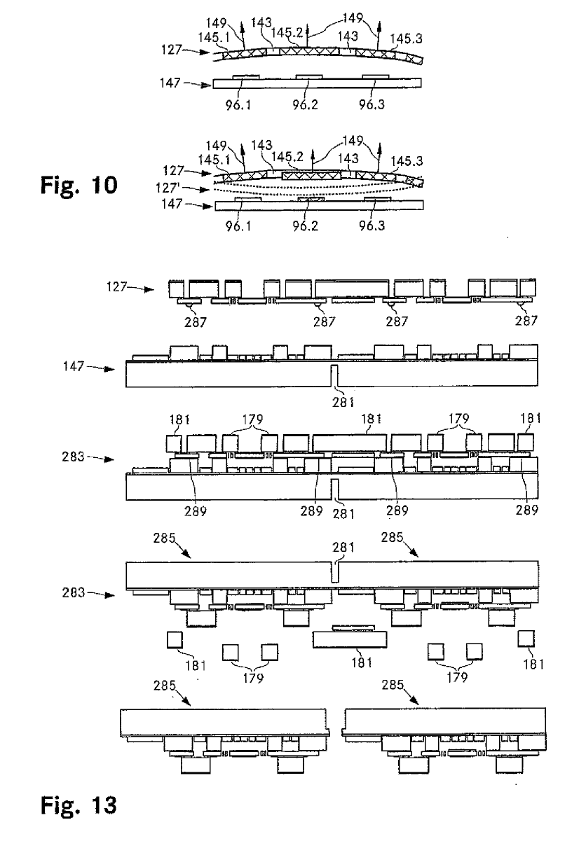

FIG. 10 illustrates a small excerpt from the cross section of a wafer sandwich of the mirror chip 127 from FIG. 8 and the electrode chip 147 from FIG. 9. The upper illustration in FIG. 10 shows this wafer sandwich without activated electrodes 96.1, 96.2, 96.3, while the lower illustration shows this wafer sandwich with an activated electrode 96.2. The mirror chip 127 has a bulge (shown exaggerated in the illustration) such as can be caused by mechanical stresses (temperature change, packaging).

Furthermore, the tongues 145.1, 145.2, 145.3 with the intervening cutouts 143 and a respective normal vector 149 to a mirror lying on the respective tongue 145 can be discerned. Owing to the bulge, said normal vectors 149 point in slightly different directions. It should be taken into consideration, however, that these direction deviations and also the offset of the central tongue 145.2 are shown greatly exaggerated in FIG. 10. If one of the electrodes, for example the electrode 96.2, is then activated, it exerts an electrostatic force on the mirror on the tongue 145.2. If the mirror chip 127 were not subdivided into the tongues 145.1, 145.2, 145.3 by the cutouts 143, an undefined and unpredictable change in the bulge could arise, which is illustrated in FIG. 10 by the mirror chip position 127′ illustrated by dashed lines. In this case, the associated normal vectors would point in completely different directions from before and the spacings between the electrodes and the mirrors would be greatly altered.

Since the mirror chip 127 comprises the cutouts 143, however, the central tongue 145.2 experiences, by virtue of correspondingly chosen spring and base dimensions, a negligibly small offset downwards, but the membrane of the mirror chip 127 remains in the same position and the outer tongues 145.1, 145.3 are completely decoupled on the central tongue 145.2. The alignment of the mirrors on the tongues 145.1, 145.2, 145.3 and hence the alignment of the normal vectors 149 and also the spacing between the mirrors and the electrodes 96.1, 96.2, 96.3 likewise remain practically unchanged.

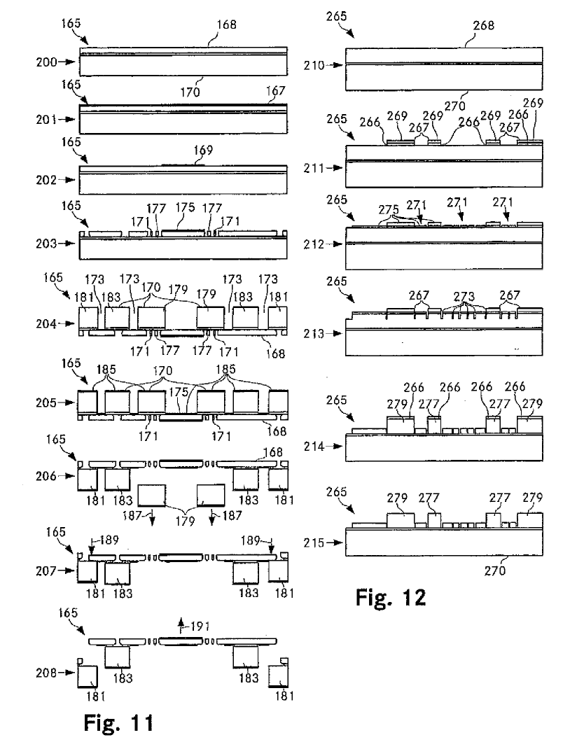

FIG. 11 shows a schematic illustration of the individual process steps for producing a mirror chip comprising a micromirror arrangement according to the invention or comprising one or at the same time a multiplicity of arrays of such micromirror arrangements.

The production of the electrode chip begins on its front side 168 in step 200 with an SOI wafer 165, the top layer thickness of which is typically approximately ten micrometres. In step 201, this wafer 165 is first completely metallized, that is to say provided with a metal layer 167. In the subsequent step 202, the wafer 165 is patterned by means of a lithography etching process in such a way that the metal layer 167 remains only on those locations 169 where micromirrors are finally situated.

Step 203 involves prescribing, by means of photolithography, the later structures such as, for instance, the mirror 175, the springs 171 and the frames 177 on the top layer. In step 204, these structures are transferred into the silicon by means of DRIE (Deep Reactive Ion Etching). As a result of so-called “notching”, the structures are additionally undercut at their edges with respect to the oxide. As a result, in the case of thin structures, e.g. the later springs 171, a reduction of the structure height is achieved, similar to the delay mask process. In the case of wider structures such as the mirrors 175, by contrast, the “notching” only results in edge breaking, but has no influence on the thickness of the mirror 175 overall. In other words, the “notching” makes it possible to reduce the height of the springs 171 in relation to the height of the mirrors 175. The wafer 165 is then processed on its rear side 170.

The processing of the rear side 170, likewise also illustrated in step 204, again starts with a lithography process in order to etch free the rear-side surface of the mirror 175. Trenches 173 (grooves) are furthermore etched in order to enable access for the HF vapour in the subsequent steps. What is important in this step 204 is that the springs 171 remain completely covered with a protective frame 179. Furthermore, a holding frame 181 remains on the wafer 165 between the chips in order to still hold the chip in the wafer 165. Further supporting structures 183 also remain.

In step 205, the rear side 170 is metallized. Metal 185 is deposited on the entire rear side 170, such that the rear-side surfaces of the mirrors 175, of the trenches 173 and also of the protective frames 179, of the holding frames 181 and of the supporting structures 183 are covered with metal 185. Since the springs 171 are protected by the protective frames 179, no metal is deposited on the springs 171.

For step 206, the wafer is turned over again, such that its front side again faces upwards. Step 206 shows the use of HF vapour (hydrofluoric acid vapour). This makes it possible to remove the oxide (insulating layer) in the wafer 165 also below the protective frames 179 and the holding frames 181. A crucial factor in this case is the size of the overlaps between the top layer and the structures to be stripped out, that is to say the size or width of those areas with which the protective frames 179 and the holding frames 181 are connected to the top layer via the oxide. The overlap is chosen to be smaller in the case of the protective frames 179 than in the case of the holding frames 181. The overlap is largest in the case of the supporting structures 183. As a result, during the action of the HF vapour, firstly the oxide layer for the protective frames 179 is etched through and said protective frames are released from the wafer 165, which is indicated by the arrows 187, while the holding frames 181 and the supporting structures 183 are still connected to the wafer 165.

If the HF vapour is allowed to act further, which is illustrated in step 207, the individual mirror chips are also released from the wafer frame in temporally delayed fashion and are left lying loosely in said frame. In other words, the chips fall as it were onto the holding frame 181, which is indicated by the arrows 189. The chips can then be picked individually from the frame without any force acting on the fragile microstructures. Since no force has to be expended for this singulation, the microstructures are not destroyed and the yield is correspondingly very high, that is to say that there is only a very small proportion of rejects.

After the singulation of the chips in step 207, the chips that are then lying freely in the wafer frame can be picked out individually, that is to say lifted out from the wafer frame. This is represented by the arrow 191 in step 208. In the case of a wafer having a diameter of 100 mm, approximately 16 individual chips each having an array of four by thirty-two mirrors can be produced in this way.

If it is not desired to separately combine each individual mirror chip with an individual electrode chip in each case, it is also possible to wait with the singulation of the chips. In this variant, the chips are not singulated immediately, rather firstly the entire mirror wafer is joined together with a previously fabricated electrode wafer (wafer bonding). Before or after the wafer bonding, the chip boundaries of the electrode wafer are partly incised from the rear side by means of a wafer saw. After the wafer bonding, the wafer sandwich is exposed to the HF vapour, such that firstly the protective frames 179 are released from the wafer. With sustained action of the HF vapour, the oxide which connects the mirror chips to the wafer frame also dissolves and the frame can be detached. From the remaining chip assemblage individual chips can be singulated by slight pressure and be removed.

FIG. 12 shows a schematic illustration of the individual process steps for producing an electrode chip comprising one or a multiplicity of electrode arrangements.

In step 210, the production of the electrode chip begins on the front side 268 thereof with an SOI wafer 265, the top layer thickness of which is typically approximately 150 micrometres. The wafer 265 is firstly oxidized wet-thermally.

The resulting oxide layer 266 is e.g. approximately 0.5 micrometre. In step 211, this oxide layer 266 is patterned by photolithography and a subsequent ion etching process, with the result that corresponding oxide structures 267 become visible. These oxide structures 267 are still covered with photoresist 269 and they define the walls of those structures such as the later screen, for example, which have the full structure height. The photoresist 269 from the first photolithography step is then removed, for example by means of oxygen plasma.

Step 212 shows a second photolithography, which is used to define those regions 271 which are intended to have a smaller structure height. These are for example the regions 271 of the later electrodes, conductor tracks and pedestals for the aligning and spacing devices. For this purpose, a layer of photoresist 275 is applied, no photoresist being applied at the places where the interspaces between these structures will subsequently be situated.

In the next step 213, by means of DRIE, the top layer of the wafer 265 is etched to a depth of approximately one third of the total height of the top layer in those regions which are not covered by photoresist 275, with the result that narrow slots 273 arise which correspond to the later electrode height, that is to say have a height of approximately 30 to 40 micrometres.

Afterwards, the photoresist 275 from the second lithography is remove and, in step 214, by means of DRIE, etching is completed as far as the inner insulation layer of the wafer 265. This already uncovers the screens 277 and further connecting structures 279, these still being covered by the oxide layer 266.

In the last step 215, said oxide layer 266 is finally also removed, with the result that the patterning of the electrode chip is finished. The rear side 270 of the wafer 265 is not patterned.

There are a number of variants for mounting a mirror chip and a corresponding electrode chip. In a first variant, the chips of a wafer are individually joined together and connected to one another. The chips of both wafers are singulated prior to mounting. In the case of the mirror wafer, this is done using HF vapour as described above. In the case of the electrode wafer, the rear side of the wafer (substrate side) is incised. The chips are singulated by breaking by means of slight pressure on the respective electrode chips. Since these electrode chips do not have such fragile structures like the springs of the mirror chips, this can be done safely. Afterwards, a glass fibre having a diameter of approximately 140 micrometres is pressed into the corresponding grooves of the electrode chip and held in position there by the leaf springs. In the next step, the MEMS chip, that is to say the mirror chip, is positioned with its front side on the electrode chip in such a way that the fibre groove at the MEMS chip latches on the glass fibre. This permits passive alignment of the two chips with one another. A precision of better than one micrometre is achieved in this way.

Finally, the chips are fixed relative to one another, for example by means of UV-curing epoxy or a soldering process. Since the fibre, as already described above, bears on a pedestal having the same height as the electrodes, the spacing between the micromirror and electrode surface is determined exclusively by the diameter of the glass fibre. The advantage here is that variations in the “delay mask process” can lead to different electrode heights, but the spacing between micromirror and electrode surface nevertheless always remains the same.

In a second variant, the two wafers are joined together and connected to one another (wafer level mounting) before the chips are singulated. The design of MEMS chip and electrode chip allows this. This mounting variant is illustrated in FIG. 13. Before the protective frames 179 are stripped from the MEMS chips by means of HF vapour, the mirror wafers are very robust and the fine MEMS structures (e.g. the springs 171) are not damaged in additional process steps. This permits the application of, for example, solder or some other material for low-temperature “wafer bonding”. The solder is applied as solder balls e.g. on the remaining locations on the rear side of the mirror wafer (outside the mirror regions). The wafer level bonding between MEMS wafer and electrode wafer is subsequently effected, soldering connections to the corresponding connecting structures 279 of the electrode wafer being produced in accordance with the solder balls applied. Other bonding possibilities are e.g. gold eutectic bonding or adhesive-bonding connections. However, the connections produced in this way must withstand the subsequent HF vapour sufficiently robustly.

In the example illustrated in FIG. 13, on the electrode chip 147 prior to the wafer bonding, the chip boundaries 281 are incised from the rear side, that is to say the substrate side of the electrode chip 147, by means of a wafer saw. Afterwards, the mirror chip 127 and the electrode chip 147 are joined together by solder balls 287 being applied to corresponding locations of the front side of the mirror chip 127 and the two chips then being soldered together. The wafer sandwich 183 arises as a result, the corresponding soldering connections 289 being marked in FIG. 13.

Only then is the wafer sandwich 283 exposed to the HF vapour, such that firstly the protective frames 179 and, in a temporally offset manner, the holding frames 181 are released from the wafer sandwich 283. In other words, firstly the protective frames 179 fall out and afterwards, in a temporally offset manner, the connections of the holding frames 181 to the MEMS electrode chips 285 are released and the holding frame 181 can be removed. By means of slight pressure, the individual MEMS electrode chips 285 break apart along the chip boundaries 281 and can be singulated from the remaining chip assemblage in this way and finally be removed.

This second variant permits the accurate positioning of all the chips in a single work operation. By virtue of mirror chip and electrode being connected by means of soldering tin, at the same time screen and micromirror are electrically contact-connected to earth. Consequently, this variant of the mounting of the chips is extremely economic and permits the production of such micromirror chips in large quantities at favourable prices.

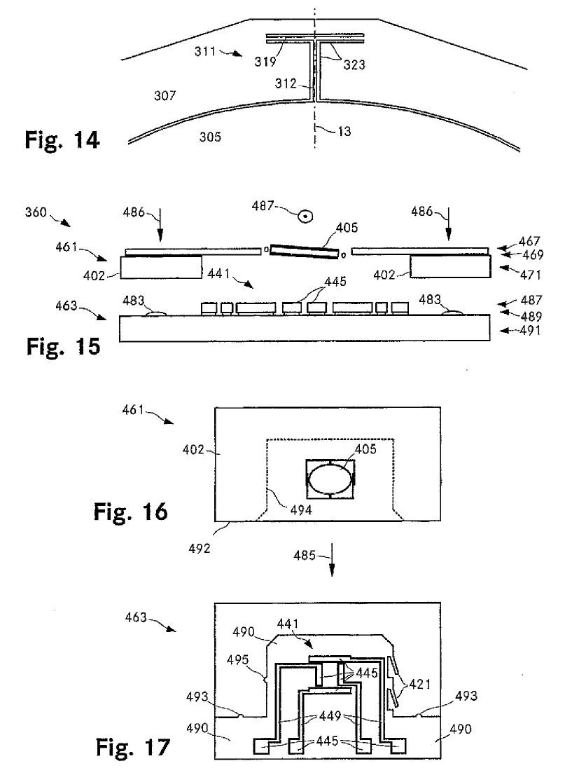

FIG. 14 illustrates a further embodiment of a torsion spring 311 for connecting the mirror 305 to the frame 307. The torsion beam 312 of this torsion spring 311, which beam in turn defines the rotation axis 13 of the mirror 305, is formed together with the connecting piece 319 to the frame 307 in T-shaped fashion, the torsion beam 312 forming the longitudinal beam and the connecting piece 319 forming the transverse beam of the T. The torsion beam 312 is connected to the mirror 305 at its lower end (according to the illustration in FIG. 14). Its upper end is correspondingly not connected directly to the frame 307, but rather centrally to the connecting piece 319, the two ends of which are then connected to the frame 307. For this purpose, the frame 307 comprises a T-shaped cutout 323, the torsion beam 312 running in the longitudinal beam of the T-shaped cutout 323 and the connecting piece 319 running in the transverse beam of the cutout 323. What is achieved by this arrangement is that forces which act on the mirror arrangement in the direction of the rotation axis 13 can be compensated for by a deformation of the connecting piece 319. In this way, such forces have no influence on the functionality of the mirror device, in particular on the actuation of the mirror 305. Such forces can arise for example as a result of stresses in the torsion beam 312 itself, which are brought about for instance by the production process.

FIGS. 15-17 show a further mounting variant and an aligning and spacing device for the mirror chip 461 and the electrode chip 463 of a micromirror device 460, in the case of which it is ensured that the mutually assigned mirror 405 and electrode arrangement 441 are also actually precisely opposite one another and comply with the desired spacing from one another.

FIG. 15 shows a schematically illustrated cross section through the micromirror device 460, the mirror chip 461 and the electrode chip 463 being illustrated as separate from one another instead of joined together, for the sake of simplicity. FIGS. 16 and 17 each show a plan view of the mirror chip 461 and the electrode chip 463, respectively, from the top layer side.

The mirror chip 461 and also the electrode chip 463 are again produced in each case from an SOI wafer having respectively a substrate layer 471, 491, an insulation layer 469, 489 and a top layer 467, 487. The mirror chip 461 again comprises the mirror 405 together with a suspension and the electrode chip 463 again comprises an electrode arrangement 441 having a plurality of electrodes 445 which are connected to corresponding bonding pads 400 via conductor tracks 449.

In contrast to the micromirror device from FIG. 6, the mirror chip 461 and the electrode chip 463 here are arranged in such a way that the substrate layer 471 of the mirror chip 461 faces the top layer 487 of the electrode chip 463.

For mutually aligning the mirror chip 461 and the electrode chip 463, the mirror chip 461 comprises a frame region 402 laterally with respect to the mirror 405 and at the side facing the electrode chip 463, said frame region being patterned from the substrate layer 471. This frame region 402 virtually corresponds to the regions 102 from FIG. 6, where in contrast to FIG. 6, in FIG. 15 these frame regions 402 are arranged on the underside of the mirror chip 461 and not on the top side of the electrode chip 463.

When mirror chip 461 and electrode chip 463 are joined together, the underside of said frame region 402 is then brought into contact with the top side of the substrate layer 491, such that the spacing H of the electrodes 445 from the underside of the mirror 405 is defined as follows, or can be set as desired by a suitable choice of the corresponding layer thicknesses:

H=(Hₛₛ+H_{SI})−(H_{ED}+H_{EI})

where Hₛₛ denotes the layer thickness of the substrate layer 471, H_{SI} denotes the layer thickness of the insulation layer 469, H_{ED} denotes the layer thickness of the top layer 487 and H_{EI} denotes the layer thickness of the insulation layer 489. Depending on how precise the spacing H or the specifications in respect thereof have to be, it is also possible if need be to take account of the layer thickness of the metal coating of the mirror 405 by also subtracting this. The following approximation can also be used for H, by disregarding the layer thicknesses of the two substrate layers:

H=H_{SS}−H_{ED}

The joining-together process is effected by placing the mirror chip 461 onto the electrode chip 463 in the direction of the arrows 486 and then pushing it onto the electrode chip 463 in the direction of the arrow 485.

For the horizontal alignment, two reference areas 492, 494 are provided on one of the two chips, on the mirror chip 461 in this example, and reference points 493, 495 are provided on the respective other chip, on the electrode chip 463 in this example. The reference areas 492, 494 are arranged for example on an outer and an inner side, respectively, of the frame region 402 of the mirror chip 461 and the reference points 493, 495 are arranged for example on the outer sides of the structures 490 of the electrode chip 463. The reference areas 492, 494 are preferably at an angle different from 0 degrees with respect to one another. They are perpendicular to one another in the present example. The structures illustrated as reference points 493, 495 in cross section are inherently elongate elevations in the direction of the plan view of the electrode chip 463.

When the chips are joined together, the reference points 493, 495 serve as a bearing for the reference areas 492, 494 of the mirror chip. The three reference points 493, 495 on which the reference areas 492, 494 bear result in a geometrically defined three-point bearing, mirror chip 461 and electrode chip 463 being pressed together by springs, for example leaf springs 421, fitted on the opposite side of the reference point 495.

Since the spacings of the mirror 405 and of the electrodes 445 with respect to these reference areas are precisely defined and known or can be set as desired by suitable processing of the wafers, after mirror chip 461 and electrode chip 463 have been joined together, the mirror 405 and the electrodes 445 are precisely mutually aligned in the desired manner and are also held in their positions by the leaf springs 421.

This aligning and spacing device thus ensures that the mutual position of mirror 405 and electrode arrangement 441, that is to say their horizontal alignment and also their spacing, are precisely as desired.

It would also be possible, of course, to provide the reference areas on the electrode chip and the reference points on the mirror chip or reference areas instead of reference points.

FIG. 15 shows yet another aspect, namely the connection of mirror chip 461 and electrode chip 463. For this purpose, two solder points or solder bumps 483 composed, for example, of gold or some other known solder are applied for example on the substrate layer 491 of the electrode chip 463. When the two chips are joined together, the material of said bumps is liquefied in a known manner, the two chips being fixedly connected to one another after the solder has solidified. Since the solder can affect the spacing of mirror 405 and electrodes 445, this can already be taken into account in the design of the micromirror device. Another possibility for connecting the two chips is so-called “gold stud bump” technology, which involves applying a gold contact to the substrate layer 491. The connection of the chips is then effected as a type of bonding by means of ultrasound (or using sound waves of other frequencies such as e.g. in the range of microwaves), in a manner similar to flip-chip bonding already mentioned. By means of these types of connection, the two chips can at the same time also be electrically contact-connected to one another.

Such micromirror chips can be used in many different applications. One main application is in telecommunications, that is to say in the optical transmission of signals. In this case, the signal-carrying light beams, which are typically directed onto such a micromirror by means of an optical fibre, are coupled into one of a plurality of further optical fibres by the micromirror depending on the driving of the electrodes and corresponding rotary position of the mirror about its rotation axes. In this way it is possible to produce e.g. so-called X-connects (pronounced: cross-connects), optical matrix switches. By means of such matrix switches, the light from each of, for example, 50 optical fibres can be deflected by means of a micromirror and be coupled into any of said 50 optical fibres in a controllable manner. Such X-connects are used in satellite technology, for example, in order to be able to reprogram, i.e. reconfigure, high-frequency data links in a simple manner.

A further application in data transmission consists in the so-called routing of wavelengths in optical networks, where the data to be transmitted are modulated onto different wavelengths of a light beam (wavelength division multiplexing).

Such micromirror arrays can also be used in so-called ROADM (Reconfigurable Optical Add Drop Multiplexer) in order likewise to filter out one or a plurality of specific wavelengths from an optical fibre.

Micromirrors of this type can also be used in satellite communication, for example from a satellite to an aircraft or vice versa. Such communication links can be sensitively disturbed by vibrations such as are present e.g. in the case of aircraft in flight. Said vibrations can be filtered out and stabilized with the aid of such micromirrors, whereby the communication can be improved.

Spectroscopy is a further possibility for the application of such micromirror arrays. In this case, the light from a light source is fanned out into its spectral colours with the aid of a prism, for example. By means of a micromirror array, in each case a desired wavelength (or else a plurality of wavelengths) can then be selected in a targeted manner and deflected to a specific location, while the remaining wavelengths are not processed further.

However, such micromirror arrays can also be used far more diversely, for example in optical coherence tomography.

To summarize, it can be established that the invention makes it possible to provide a micromirror arrangement in which each mirror can be rotated in each case in decoupled fashion about one or both of its rotation axes, which operates in a drift-free manner and in which adjacent electrodes and conductor tracks do not affect the switching behaviour of a micromirror (no crosstalk). This permits the micromirror arrangement to be embodied in a manner free of feedback, with the result that not only is the production of this micromirror arrangement less complicated and therefore more cost-effective, but the entire arrangement also takes up less space than conventional micromirror arrangements. It is nevertheless possible to arrange a large number of such micromirrors in an array with a very high packing density.

1. Micromirror device comprising a mirror arrangement patterned from a semiconductor layer, in particular a silicon layer, which comprises a base structure (9), a micromirror and a frame structure arranged between the base structure and the micromirror, the micromirror is connected to the frame structure via two articulated joints defining a first rotation axis of the micromirror, and the frame structure is connected to the base structure via two articulated joints defining a second rotation axis, wherein the two rotation axes form an angle of greater than 0 degrees, characterized in that the articulated joints defining the first rotation axis each comprise a torsion spring and the articulated joints defining the second rotation axis each comprise a bending spring.

2. Micromirror device according to claim 1, wherein each bending spring comprises precisely one bending beam arranged perpendicular to the second rotation axis, which bending beam is connected to the frame structure at a first end and to the base structure at a second end, such that mechanical stresses in the direction of the second rotation axis can be compensated for by an offset of the bending beams.

3. Micromirror device according to claim 1, wherein each torsion spring comprises precisely one torsion beam arranged parallel to the first rotation axis, said torsion beam being connected to the micromirror at a first end and to the frame structure at a second end.

4. Micromirror device according to claim 1, wherein the micromirror has a metal coating on at least one surface of the semiconductor layer and the torsion springs and the bending springs are free of the metal coating.

5. Micromirror device according to claim 1, wherein the semiconductor layer is a top layer of a first SOI wafer, which furthermore comprises an insulation layer and a substrate layer.

6. Micromirror device according to claim 5, wherein it comprises an electrode arrangement patterned from a top layer of a second SOI wafer and having a plurality of electrodes, the second SOI wafer furthermore comprises an insulation layer and a substrate layer, the mirror arrangement and the electrode arrangement are placed against one another in such a way that that surface of the top layer which is remote from the insulation layer of the first SOI wafer and that surface of the top layer which is remote from the insulation layer of the second SOI wafer face one another and that the electrodes and the micromirror are opposite one another and have a defined spacing with respect to one another, such that the micromirror can be rotated about in each case at least one of the two rotation axes electrostatically by application of an electrical voltage to at least one of the electrodes.

7. Micromirror device according to claim 6, wherein the electrode arrangement is at least partly surrounded by a screen patterned from the top layer of the second SOI wafer, in order to screen the electrodes from external electric fields.

8. Micromirror device according to claim 6, wherein it comprises a spacing and aligning device comprising, on that surface of the top layer which is remote from the insulation layer of the first SOI wafer, a first cutout and, on that surface of the top layer which is remote from the insulation layer of the second SOI wafer, a second cutout and also a spacer, wherein the spacer is inserted into a free space formed by the two cutouts between or in the two top layers of the two SOI wafers, and the spacer is formed in particular as a glass fibre having a circular-disc-shaped cross section.

9. Micromirror array comprising a plurality of micromirror devices according to claim 1 which are arranged in an array.

10. Micromirror array according to claim 9, wherein all the mirror arrangements of the micromirror devices are patterned from a top layer of a first SOI wafer, and, if the micromirror devices comprise an electrode arrangement, all of said electrode arrangements are patterned from a top layer of a second SOI wafer, wherein the two SOI wafers furthermore comprise a substrate layer and an insulation layer arranged between the substrate layer and the top layer, the mirror arrangements with the electrode arrangements are placed against one another in such a way that that surface of the top layer which is remote from the insulation layer of the first SOI wafer and that surface of the top layer which is remote from the insulation layer of the second SOI wafer face one another and that an electrode arrangement and a mirror arrangement are in each case opposite one another and have a defined spacing with respect to one another.

11. Micromirror array according to claim 9, wherein the array comprises four rows of micromirror devices with parallel first and coincident second rotation axes and at least two columns of micromirror devices with coincident first and parallel second rotation axes, and the top layer of the first SOI wafer has a cutout for compensation of mechanical stresses in the direction of the first rotation axes between the second and the third row of micromirror devices, and wherein the top layer of the first SOI wafer has a cutout for compensation of mechanical stresses in the direction of the second rotation axes between the micromirror devices.

12. Method for producing a micromirror device according to claim 1, wherein a mirror arrangement having a base structure, a micromirror and a frame structure arranged between the base structure and the micromirror is patterned from a semiconductor layer, in particular a silicon layer, and two articulated joints that define a first rotation axis of the micromirror and connect the micromirror to the frame structure and two articulated joints that define a second rotation axis and connect the frame structure to the base structure are patterned from the semiconductor layer, wherein the two rotation axes form an angle of greater than 0 degrees, characterized in that the articulated joints defining the first rotation axis are patterned from the semiconductor layer as an articulated joint each comprising a torsion spring and the other two articulated joints defining the second rotation axis are patterned from the semiconductor layer as an articulated joint each comprising a bending spring.

13. Method according to claim 12, wherein at least one surface of the semiconductor layer of the micromirror is provided with a metal coating, wherein the torsion springs and the bending springs are kept free of the metal coating.

14. Method according to claim 12, wherein the mirror arrangement is patterned from a semiconductor layer of an SOI wafer that is referred to as the top layer, wherein the SOI wafer further comprises an insulation layer and a substrate layer.

15. Method according to claim 12, wherein an electrode arrangement having a plurality of electrodes is patterned from a top layer of a second SOI wafer, which furthermore comprises an insulation layer and a substrate layer, the mirror arrangement and the electrode arrangement are placed against one another in such a way that the electrodes and the micromirror are opposite one another and have a defined spacing with respect to one another.

16. Method according to claim 12, wherein a plurality of mirror arrangements are patterned from the top layer of the first SOI wafer, a number of electrode arrangements corresponding to the plurality of mirror arrangements are patterned from the top layer of a second SOI wafer, wherein the mirror arrangements and the electrode arrangements are placed against one another in such a way that an electrode arrangement and a mirror arrangement are in each case opposite one another and have a defined spacing with respect to one another.
